(19) United States
(12) Patent Application Publication
(10) Pub. No.: US 2002/0066988 A1
(43) Pub. Date: Jun. 6, 2002

(54) Modular stairway system production benches

(75) Inventor: Gilles Couture, St. Armand (CA)

Correspondence Address: OGILVY RENAULT, 1981 MCGILL COLLEGE AVENUE, SUITE 1600, MONTREAL, QC, H3A2Y3, CA

(73) Assignee: Stairframe Systems Inc.

(21) Appl. No.: 09/920,428

(22) Filed: Aug. 1, 2001

(30) Foreign Application Priority Data
Sep. 27, 2000 (CA) 2,321,167
Jun. 14, 2001 (CA) 2,350,637

(51) Int. Cl. B25B 1/00

(52) U.S. Cl. 269/37; 269/909

(57) ABSTRACT

Benches are proposed for use in the production of modular stairways. A bench for mounting step supports to stringers of a modular stairway frame comprises racks for holding stringers therein, jigs for releasably locking the step supports therein, and a mechanism connecting the racks to the jigs for (i) equally spacing and rotating the steps supports adapted therein with respect to the racks, and (ii) mounting identical or symmetrically identical step support and stringer assemblies. A bench for mounting an angled step post of a modular stairway frame comprises jigs for holding support plates and vertical posts, frames for holding step supports, and a mechanism connecting the jigs and the frames for ensuring a precise distancing of the support plates, the step supports, and the vertical posts adapted therein. A bench for mounting a landing post of a modular stairway frame comprises jigs for holding support plates and vertical posts therein, frames for holding step supports therein, and a mechanism connecting the jigs and the frames for ensuring a precise distancing of the support plates, the step supports and the vertical posts adapted therein.

### FIELD OF THE INVENTION

The present invention relates to staircases and, more particularly, to adaptable jigs to create the components of a kit for mounting the modular stairway system on site.

### BACKGROUND ART

Typically, staircases are completely produced on site with the various components being cut to size as the staircase is progressively erected on site. It has been proposed to completely assemble a staircase in the factory such that a pre-assembled staircase is delivered to the construction site for direct and easy installation thereat. Such a modular staircase is disclosed in the present inventor's co-pending Canadian Application No. 2,149,981, which was issued for public inspection on Nov. 24, 1995.

A further application of the present inventor was issued for public inspection on Jan. 13, 2000 under the International Publication No. WO 00/01902. This application introduces a modular stairway system with the various components previously mounted in plant and comprising temporary risers and steps for using the stairway during construction. Once the construction is finished, the permanent wooden risers and steps can be installed.

### SUMMARY OF THE INVENTION

It is therefore an aim of the present invention to provide adaptable jigs for the fabrication and assembly of individual components of a modular staircase system.

Therefore, in accordance with the present invention, there is provided a bench, adapted for mounting step supports to stringers of a modular stairway frame, comprising:

racks, adapted for holding stringers therein;

jigs, adapted for releasably locking the step supports therein;

a mechanism connecting said racks to said jigs, (i) for equally spacing and rotating the steps supports adapted therein with respect to said racks, and (ii) for mounting identical or symmetrically identical step support and stringer assemblies.

Also in accordance with the present invention, there is provided a bench, adapted for mounting an angled step post of a modular stairway frame, comprising:

jigs, adapted for holding support plates and vertical posts;

frames, for holding step supports;

a mechanism connecting said jigs and said frames, for ensuring a precise distancing of the support plates, the step supports, and the vertical posts adapted therein.

Further in accordance with the present invention, there is provided a bench, adapted for mounting a landing post of a modular stairway frame, comprising:

jigs, adapted for holding support plates and vertical posts therein;

frames, adapted for holding step supports therein;

a mechanism connecting said jigs and said frames, for ensuring a precise distancing of the support plates, the step supports and the vertical posts adapted therein.

### BRIEF DESCRIPTION OF THE DRAWINGS

Having thus generally described the nature of the invention, reference will now be made to the accompanying drawings, showing by way of illustration preferred embodiments thereof, and in which:

FIG. 1 is a perspective view of a modular stairway frame of the prior art;

FIG. 2 is a schematic plan view of a mounted modular stairway of the prior art;

FIG. 3 is a perspective view of a stringer and step support bench in accordance with the present invention;

FIG. 4 is a partly sectioned plan view of the stringer and step support bench;

FIG. 5 is a partly sectioned side elevational view of the stringer and step support bench;

FIG. 6 is a perspective view of bottom portions of jigs on the stringer and step support bench;

FIG. 7 is a perspective view of top portions of jigs on the stringer and step support bench;

FIG. 8 is a perspective view of an angled step post bench in accordance with the present invention;

FIG. 9 is a perspective view of a table of the angled step post bench;

FIG. 10 is a perspective view of a first step support jig for the angled step post bench;

FIG. 11 is a perspective view of post holders of the angled step post bench;

FIG. 12 is a perspective view of a lower support plate holder of the angled step post bench;

FIG. 13 is a perspective view of an intermediate support plate holder of the angled step post bench;

FIG. 14 is a perspective view of a upper support plate holder of the angled step post bench;

FIG. 15 is a perspective view of a second step support jig for the angled step post bench;

FIG. 16 is a schematic plan view of the second step support jig for the angled step post B bench;

FIG. 17 is a perspective view of a transmission of the angled step post bench;

FIG. 18 is a perspective view of a landing post bench in accordance with the present invention;

FIG. 19 is a perspective view of a first step support jig of the landing post bench; and

FIG. 20 is a perspective view of a support plate jig and a second step support jig of the landing post bench.

### DESCRIPTION OF THE PREFERRED EMBODIMENTS

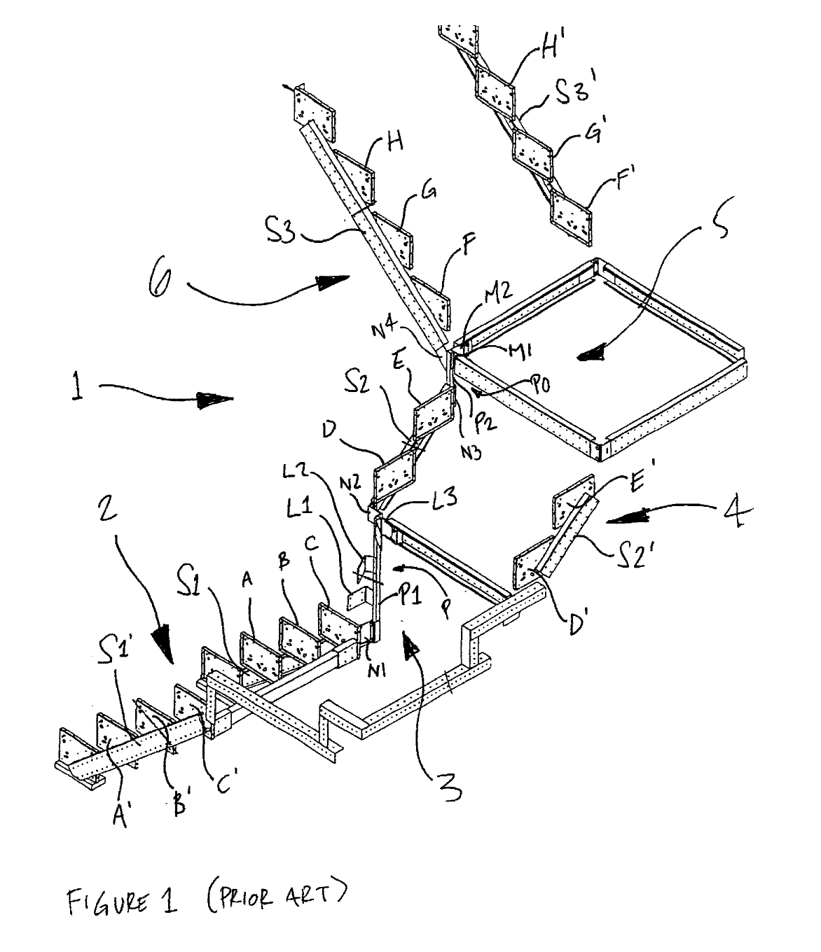

For illustration of the present invention, a modular stairway frame of the prior is generally shown at 1 in FIG. 1. The stairway frame 1 comprises straight portions 2, 4 and 6, interconnected by an angled step section 3 and a landing step section 5. As seen in FIG. 2, a stairway 7 resulting from the stairway frame 1 is shown with the above-mentioned sections.

Returning to FIG. 1, the first straight portion 2 comprises a stringer S1, whereto step supports A, B and C amongst others are joined. The first straight portion also comprises a stringer S1′, symmetrically identical to the stringer S1 and symmetrically opposed thereto, Straight portions 4 and 6 are similar to straight portion 2 in having opposed stringers but, according to the desired shape of the stairway Q, may be supporting varying quantities of step supports. For instance, stringers S2 and S2′ of the straight portion 4 both have two step supports, D and E, D′ and E′, respectively. It is noted that the step supports are equidistantly spaced on the stringers in all above cases.

The angled step section 3 comprises a post P1, located between stringers S1 and S2 of the frame 1. Supports L1, L2 and L3 are fixedly joined to the post P1 for supporting angled steps thereon. It is once more noted that the supports are equidistantly spaced on the post P1. The angled steps are shown at T, U and V in FIG. 2

The landing step section 5 comprises a post P2, located between the stringers S2 and S3 of the frame 1. Supports M1 and M2 project laterally from the post P2, and are perpendicular one to another for supporting a landing step thereon. The landing step is shown at W in FIG. 2.

The step supports are all identical. For simplicity purposes, only the step support A will be described. In referring to another step support, for instance, step support B, like numerals will designate like parts. Thus, as seen in FIG. 1, the step support has a rectangular plate 7. Vertical flanges 8 laterally project from vertical edges thereof, whereas horizontal flanges 9 laterally project from horizontal edges thereof.

The above-described modular stairway frames are precious in saving a substantial amount of time on site. As all the components are predetermined and pre-measured, the amount of time and material saved by the use of such a system makes the installation more economical. However, for the system to provide a real economical advantage, the plant production and assembly of the modular staircase components must be very efficient and economical.

### Stringer and Step Support Bench

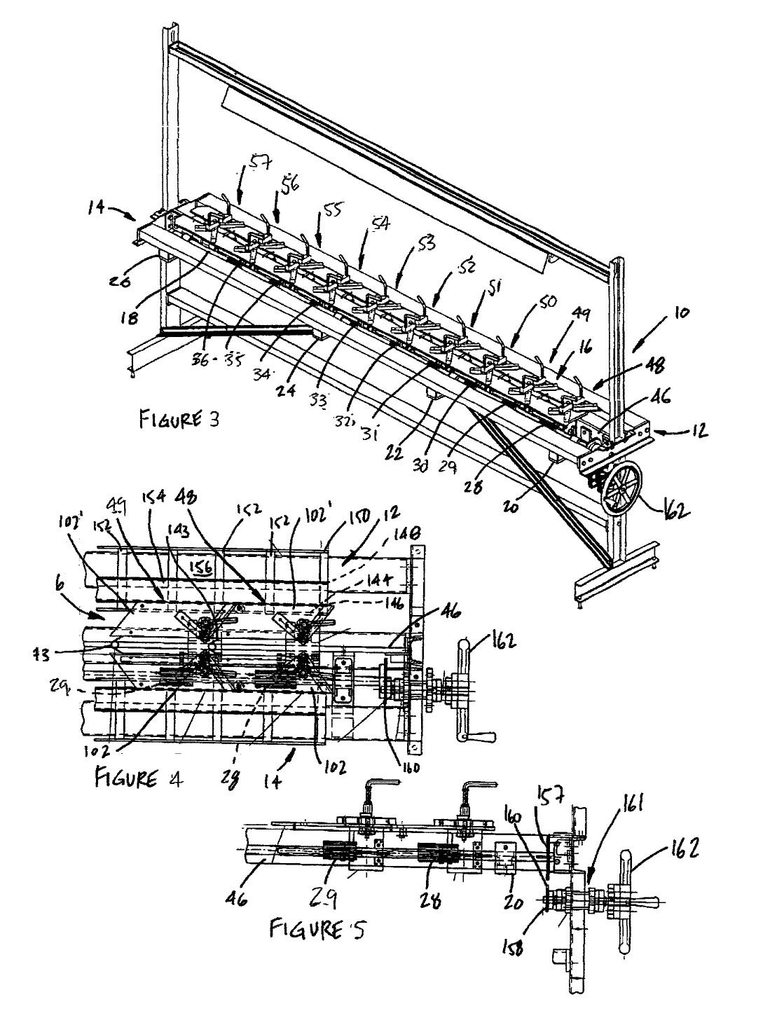

A stringer and step support bench is generally shown at 10 in FIG. 3 and comprises bedways 12 and 14, shaped to serve as abutments for stringers. Bedways 12 and 14 are parallel and spread apart by a step support positioning mechanism, generally shown at 16 in FIGS. 4 and 5.

The step support positioning mechanism 16 comprises a shaft 18, held by shaft bearers 20, 22, 24 and 26, whereby the shaft is can rotate freely about its longitudinal axis, but is prevented from translating. The shaft 18 comprises tubular gears 28 to 36 spread apart longitudinally thereon. The tubular gears 28 to 36 integrally join the shaft 18 to rotate therewith and comprise gear tooth, parallel to the shaft 18.

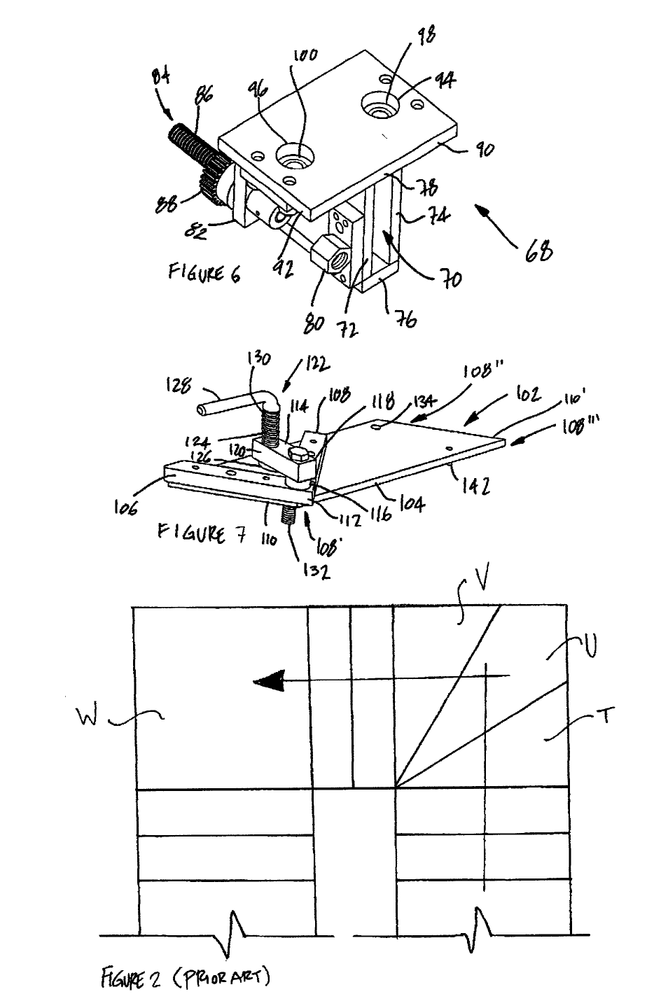

A keyway 46 extends longitudinally parallel to shaft 18. Jigs 48 to 57 are slidably disposed on the keyway 46. The jigs 48 to 57 are generally similar. Consequently, only one will be described. Like numerals for jigs 48 to 57 designate similar parts. Referring to FIG. 6, a bottom portion of either one of the jigs 48 to 57 is generally shown at 68 and defines a slot 70 for slidably engaging with the keyway 46. The slot 70 is defined by lateral walls 72, 74, a bottom wall 76 and a top wall 78. The lateral wall 72, adjacent the shaft 18, comprises at an end a tapped nut 80 fixedly connected thereto and at an opposite end a flange 82, projecting laterally therefrom. The flange 82 bears a rod 84, whereby the rod 84 is idle and free to rotate. The rod 84 is threaded at an end to define a threaded portion 86. The rod 84 further comprises a spur gear 88, located between the flange 82 and the threaded portion 86. When the jigs 48-57 are slidably disposed on the keyway 46, the lateral walls 72 are adjacent the shaft 18, such that the spur gears 88 thereof are paired up in operative contact with the tubular gears 28-36 of the shaft 18. The top wall 78 projects over the lateral walls 72, 74 to form flanges 90, 92, which define housings 94, 96 for receiving bearings 98, 100.

Referring now to FIG. 7, a top portion of the jigs 48-57 is shown at 102. The top portion 102 has a parallelogram-shaped plate 104. Abutments 106, 108 lie on a top surface of the plate 104 at an obtuse angle 106′ thereof and the abutment 106 goes beyond an edge 110 of the plate 104. The abutment 108 is adjacent an end 112 of the abutment 106, to form, from a top plan view thereof, a right angle.

A pin 116 upwardly extends from the end 112 of the abutment 106 and an arm 114 is pivotally mounted thereto at an end 118 thereof. An opposed free end 120 thereof pivotally holds a locking arm 122.

The locking arm 122 is defined by a rod 124, comprising a cam 126 at an end thereof and a handle 128 extending laterally therefrom at an opposed end thereof. The rod 124 is surrounded by a helical compression spring 130, whereby the locking arm 122 is upwardly biased in a direction opposite from the parallelogram-shaped plate 104. The cam 126 consists in an eccentric circle.

The parallelogram-shaped plate 104 further comprises a pivot pin 132, downwardly projecting from the obtuse angle 108′ thereof. A bolt 134 extends downward from the plate 104 at an opposed obtuse angle 108″ and secures an eccentric sleeve (not shown). A pin 142 further extends downward from the plate 104 at an acute angle 108″′ thereof adjacent the obtuse angle 108″.

The bottom portion 68 and the top portion 102 are interconnected by the pivot pin 132 of the latter engaged in the bearing 100 of the former. A top portion 102′ is symmetrically identical to the top portion 102 and is connected to the bottom portion 68 through the bearing 98. As best seen in FIG. 3, the top portions 102 and 102′ are symmetrically opposed on all jigs 48-57. The symmetrically identical top portions 102 and 102′ are interconnected by a coil spring 143 joining the pins 142 and 142′ thereof, whereby the top portions 102 and 102′ are continuously biased toward each other about the pivot pins 132 and 132′ thereof, which turn in the bearings 98 and 100.

The bedway 12 comprises parallel square-section rods 144, 146, 148 and 150, which are spread apart by a plurality of spacers 152, welded below therefrom. A plate 154 is disposed on top of the square-section rods 146 and 148 and longitudinally extends thereon. A groove 156 is defined by the square-section rods 148, 15O and the plurality of spacers 152, for receiving a stringer. The bed way 14 is symmetrically identical to the bed way 12 and is symmetrically opposed thereto.

A gear 157 is located at an end of the shaft 18 and is fixedly mounted thereto, The gear is operatively connected to a gear 158 by a chain 160. The gear 158 is fixedly mounted to an end of a shaft 161. The shaft 161 is idle and free to rotate and further comprises at an opposed end a turn wheel 162,

According to the straight portion of the modular stairway frame desired (i.e. number of steps, size of the steps, distance between the steps), a predetermined quantity of step supports such as A in FIG. 1 are disposed in successive jigs. The step supports are all placed in jigs using the same method. Therefore, only one insertion will be described. A step support is disposed in a jig (48-57) with the rectangular plate 7 thereof laid on the parallelogram-shaped plate 104 of the top portion 102. One of the vertical flanges 8 and one of the horizontal flanges 9 of the step support are abutted in the right angle defined by the abutments 106 and 108. The locking arm 122, as described above, is biased away from the parallelogram-shaped plate 104, thereby allowing for the step support to abutted against the abutments 106 and 108. Thereafter, the locking arm 122 is manually pushed toward the plate 104 and rotated to lock the step support by way of the cam 126 in the abutting position with the abutments 106, 108. The arm 114 pivots about the pin 116 to ensure that the cam 126 is in locking contact with both the vertical flange 8 and the horizontal flange 9 at once. It is noted from FIG. 1 that the either of the three straight portions have symmetrically identical pairs of stringers (i.e., S1 and S1′). Thus, the above-described operation of insertion of a step support is repeated to place another step support in the symmetrically identical top portion 102′. For, instance, step support A may be in the top portion 102′ of jig 50, whereas step support A′ is in the top portion 102 thereof. Likewise, other step supports are inserted in other jigs accordingly.

A rotation of the turn wheel 162 is transmitted to the gear 158 by the shaft 161, as they are both fixedly mounted thereto. The movement is then transmitted to the gear 157 by the chain 160. As mentioned earlier, the gear 157 is fixedly mounted to the shaft 18. Consequently, the shaft 18 rotates in the shaft bearers 20, 22, 24 and 26 with the tubular gears 28-36 thereon also rotating therewith. The jigs 48 to 57 are slidably mounted to the keyway 46 such that the spur gears 88 thereof are in operative contact with the tubular gears 28-44 and consequently rotate in response to the rotation of the shaft 18.

The threaded portion 86 of the bottom portion 68 of the jig 48 is engaged in the tapped nut 80 of the bottom portion 68 of the jig 49. Similarly, the threaded portion 86 of the bottom portion 68 of the jig 49 is engaged in the tapped nut 80 of the bottom portion 68 of the jig 50. The jigs 48-57 are all interconnected likewise. A rotation of the shaft 18 is transmitted to the spur gears 88 of the bottom portions 68 of the jigs 48-57 as explained above, whereby the threaded portions 86 rotate as they are integrally joined thereto. As the jig 48 is threadably engaged to the jig 49 as explained above, a rotation of the threaded portion 86 of the jig 49 will move the jig 48 away by the tapped nut 80 of the jig 48, as known in the art.

The jig 53 is anchored to the frame of the bench 10 and will be stationary in respect thereof. Jig 52 will translate in response to the rotation of its threaded portion 86 in the tapped nut 80 of the jig 53. The jig 51 will translate in response to the-rotation of its threaded portion 86 in the tapped nut 80 of the jig 52, which also translates at the same time about jig 53. Consequently, the jig 51 will translate by a combination of (i) the rotation of its threaded portion 86 in the tapped nut 80 of the jig 52, and (ii) the push resulting from the translation of jig 52 about jig 53. As the spur gears 88 of the jigs 48-57 are all submitted to the rotation of the shaft 18, the translating motion explained above will be transmitted in equal increments for successive jigs. The mechanism described above allows for an equal displacement of all jigs with respect one to another and will equally space the step supports locked thereon.

The top portion 102 of the jig 48 is in slidable contact with the top portion 102 of the jig 50. The slidable contact is between the edge 110 of the top portion 102 of the jig 50 and the edge 110′ of the top portion 102 of the jig 48. The abutment 106 of the top portions 102 projects beyond the edge 110 such as to protect the slidable contact between the edges 110 and 110′. The top portions 102′ are also slidably connected as described above.

As the jigs 48-57 are moved away from each other by the rotation of shaft 18 as explained above, the coil springs 143 will bias the pairs of parallelogram-shaped plates 104 and 104′ of the top portions 102 and 102′ of the jigs 48-57 toward each other, about bearings 98 and 100, respectively. This rotation will be equivalent for all jigs as all top portions 102 and 102′ are in operative contact. The step supports locked thereto are thus all subject to the same rotation.

The eccentric sleeves surrounding the bolts 134 of the top portions 102 and 102′ of the jigs 48-57 are disposed in a channel defined by the square section rods 144 and 146 of the bed ways 12 and 14. Consequently, a rotation of the top portions 102 and 102′ will move the bed ways 12 and 14, respectively. The eccentric sleeves 136 allow for an adjustment of the position of the bed ways 12 and 14 with respect to the jigs 48-57.

In consequence thereof, a rotation of the turn wheel 162 will allow an equal distancing of the jigs 48-57, an equal rotation of the symmetrical top portions 102 and 102′ of the jigs 48-57 and an equal displacing of the bed ways 12 and 14, holding the stringers. The result is a pair of symmetrically identical assembled stringers, ready to be used as the frame for straight portions of stairways, as shown at 2, 4 and 6 in FIG. 1.

### Angled Step Post Bench

An angled step post bench is generally shown at 180 in FIG. 8. It is used for mounting and assembling an angled step post P, shown in FIG. 1. The angled step post P comprises a post P1, three support plates extending at different angles therefrom, namely a lower support plate L1, an intermediate support plate L2 and an upper support plate L3 adapted to be attached to different risers for respectively supporting angled steps T, U and V, shown in FIG. 2. The lower end of the angled step post P comprises a connecting plate N1 for attachment to the stringer S1. The upper end of the angled step post P comprises another connecting plate N2 for attachment to a stringer S2. Step supports B, C are located on the stringer S1 and step supports D, E are located on the stringer S2.

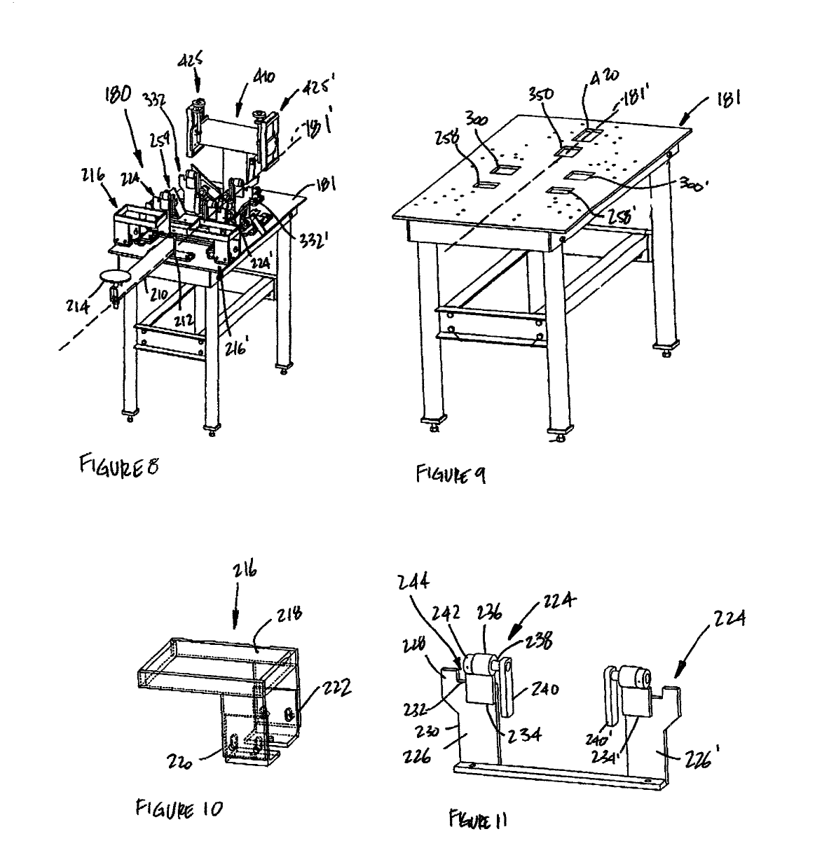

The angled step post bench in FIG. 8 is consequently adapted to assemble the angled step post P described above. The frame of the stairway shown in FIG. 1 makes a left turn at the angled steps to reach a straight portion. However, the angled steps could have served to make a right turn, in which case an angled step post symmetrically identical to the angled step post P would be needed. Mounting such an angled step post is possible with the angled step post bench 180 as it comprises two symmetrically identical portions for mounting either left-turn or right-turn angled step post. The angled step post bench 180 comprises a table 181 as shown in FIG. 9.

Returning to FIG. 8, the table 181 is passed through by a theoretical symmetrical axis 181′, hereinafter referred to as the symmetrical axis. The angled step post bench 160 further comprises an arm 210 extending at an end of the symmetrical axis and pivoting about a rod 212. A circular plate 214 is located at an opposed end of the arm 210. Like reference numerals differentiated by a ′ symbol will designate hereinafter symmetrically identical parts, symmetrically opposed about the symmetrical axis. Thus, generally shown in FIG. 8 are lower step support jigs 216 and 216′, post holder 224 and 224′, a support plate jig 259, a post holder 332, and a frame jig 425.

A lower step support jig 216, is located at a corner of the table 181 adjacent the rod 212. Referring to FIG. 10, the lower step support jig 216 comprises a rectangular frame 218 mounted on angles 220 and 222. The rectangular frame 218 is sized to be covered by step supports. The step support jig 216 is integrally fastened to the bench 180. A symmetrically identical step support jig 216′, is symmetrically opposed thereto on the table 181, about the symmetrical axis.

According to the side of the angled step post (left- or right-turn), a stringer will be placed thereon by a step support covering the frame 218′ or 218. The arm 210 is turned to be used to support the rest of the mounted stringer. For instance, the stringer S1 of FIG. 1, provided with step supports A, B and C, can be mounted on the angled stop post bench 180 by step support C engaging over step support jig 216′.

Referring to FIG. 8, a post holder 224 is located adjacent lower step support jig 216. As best shown in FIG. 11 the post holder 224 comprises an upwardly extending flat plate 226. A flange 228 extends laterally from an edge 230 thereof. The flange 228 upwardly projects beyond a top edge 232 thereof. A square plate 234 is integrally fastened to the flat plate 226 and also extends upwardly therefrom. A sleeve 236 is located at an end thereof and holds a rod 238 in slidable and rotatable contact. The rod 238, longitudinally perpendicular to the symmetrical axis, comprises at an end a handle 240 and at an opposed end a cam 242. A groove 244 is defined by the flange 228, the top edge 232 and the square plate 234, whereby a post may be received. The length of the rod 238 between the handle 240 and the cam 242 is greater than the length of the sleeve 236, whereby a slidable translation of the cam 242 is enabled. The cam 242 may consequently go over the groove 244.

The post P1 beforehand disposed in the groove 244, is locked therein by turning the handle 240 to turn the cam 242 thereon, as cam 242 was previously pushed over the groove 244. A symmetrically identical post holder 224′ is symmetrical opposed thereto about the symmetrical axis. The post holders 224 and 224′ are integrally fastened to the table 181.

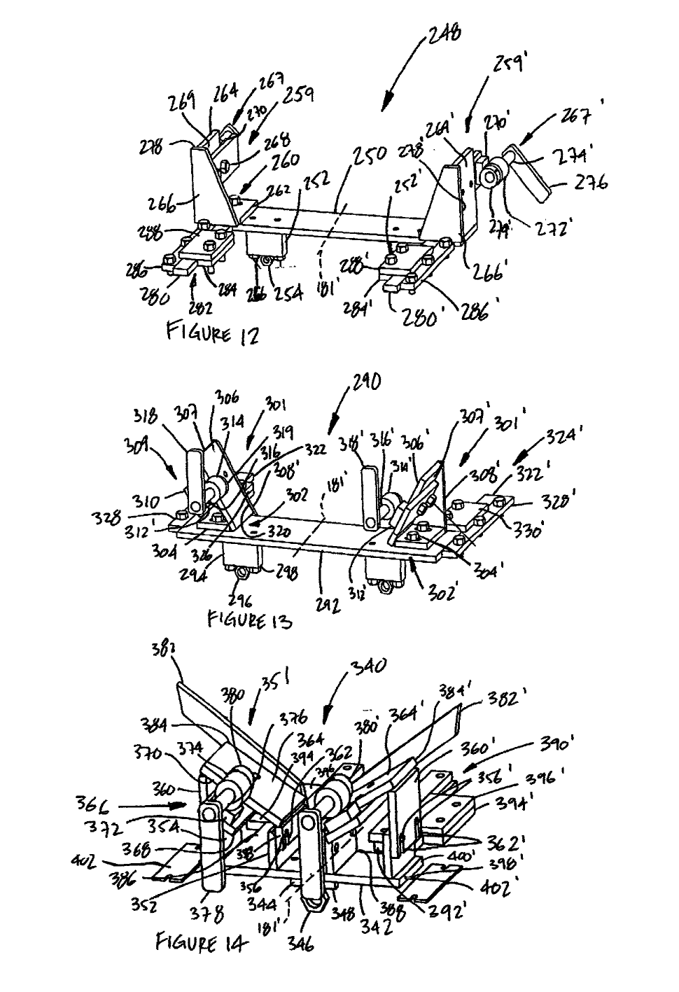

A lower support plate holder, generally shown at 248 in FIG. 12, is adjacent the post holder 224 and comprises a slender plate 250 lying on the table 181. The slender plate 250 is longitudinally perpendicular to the symmetrical axis and is centered therefrom. A rectangular block 252 extends downward from the slender plate 250, is adjacent to an end thereof and is fixedly secured thereto. A tapped nut 254 is located at a bottom edge 256 of the rectangular block 252, and is longitudinally parallel to the symmetrical axis. The rectangular block 252 and a symmetrical block 252′ penetrate the table 181 through slots 258 and 258′ shown in FIG. 9, respectively, and engage slidable contact therewith allowing for a translation of the lower support plate holder 248 parallel to the symmetrical axis.

Returning to FIG. 12, a support plate jig 259 comprises an angle 260 including a side 262 lying on an end of the slender plate 250 and a side 264 upwardly extending therefrom, at a right angle. A trapezoid plate 266 is connected to edges of sides 262 and 264, on the side of the post holder 224. A cam locking device is generally shown at 267 and comprises a square plate 268, integrally joined to a flat surface 269 of the side 264 and extending longitudinally parallel to the symmetrical axis. An end of the square plate 268 clears the flat surface 269 and is connected to a block 270. A sleeve 272, located at an end face of the block 270, as best seen on the symmetrical identical sleeve 272′ and block 270; and bears a rod 274. The rod 274 comprises at a handle an end 276 thereof and at an opposed end a cam 279. The length of the rod 274 between the handle 276 and the cam 279 is greater than the length of the sleeve 272, such that the cam 279 is free to translate and rotate therein. The cam 279 may consequently go over the side 264. The trapezoid plate 266 extends beyond the side 264 of the angle to define an abutment 278. A support plate jig 259′ is symmetrically identical to the support plate jig 259 and also comprises a cam locking device, 267′.

A guide plate 280 is located below the side 262 of the angle 260 and projects longitudinally parallel to the symmetrical axis and is also below the trapezoid plate 266. The guide plate 280 slides in a housing 282 consisting in side abutments 284 and 286 and a top plate 288 thereon. The housing 262 is integrally fastened to the table 181. A guide plate 280′ and a housing 282′ are symmetrically identical to the guide plate 280 and the housing 282, respectively, and symmetrically opposed thereto.

During the assembly of an angled step post, for instance the angled step post P of FIG. 1, the lower support plate L1 is placed in the support plate jig 259′ of the lower support plate holder 248, and locked by the cam locking device 267′. The lower support plate is positioned with the abutment surface 278′ on one direction, and is placed against the post P1 which was beforehand placed in the post holder 224′ in the other direction. The same steps apply, but for the symmetrical identical elements (without ′), if the frame was to make a right-turn at the angled step portion rather than the left-turn depicted in FIG. 1.

An intermediate support plate holder, generally shown at 290 in FIG. 13, is adjacent the lower support plate holder 248 and comprises a slender plate 292 lying on the table 181. The slender plate 292 is longitudinally perpendicular to the symmetrical axis and is centered therefrom. A rectangular block 294 extends downwardly therefrom, and is adjacent an end of the slender plate 292. A tapped nut 296 is located at a bottom edge 298 of the rectangular block 294, and is longitudinally parallel to the symmetrical axis, The rectangular block 294 and a symmetrically identical rectangular block 294′ penetrate the table 181 through slots 300 and 300′, respectively, engaging a slidable contact therewith for a translation of the intermediate support plate holder 290 upon the symmetrical axis.

The support plate jig 301, having a symmetrical support plate jig 301′, comprises an angle 302 including a side 304 lying on an end of the slender plate 292 and a side 306 upwardly extending therefrom, at an acute angle. The angle may vary as the side 306 may rotate about a hinge (not shown) connecting the side 304 thereto. A triangular plate 308 is connected to edges of sides 304 and 306, on the side away from the lower plate support holder 248. A cam locking device 309, operating in the same way as cam locking device 267 in FIG. 12, comprises a square plate 310, integrally joined to a flat surface 307 of the side 306 and extending longitudinally parallel to the symmetrical axis. An end of the square plate 310 clears the flat surface 307 and is connected to a block 312. A sleeve 314 is located at an end face of the block 312, longitudinally parallel to the symmetrical axis, and bears a rod 316 in slidable and translational engagement therewith. The rod 316 comprises at an end a handle 318 and at an opposed end a cam 319 and is longitudinally parallel to the symmetrical axis. The triangular plate 308 extends beyond the side 306 of the angle 302 to define an abutment surface 320.

A guide plate 322 is located below the side 304 of the angle 302 and projects longitudinally parallel to the symmetrical axis and is also below the triangular plate 308. The guide plate 322 slides in a housing 324 consisting in side abutments 326 and 328 having a top plate 330 thereon. The housing 324 is integrally fastened to the table 181. A guide plate 322′ and a housing 324′ are symmetrically identical to the guide plate 322 and the housing 324, respectively.

During the assembly of the angled step post P of FIG. 1, the intermediate support plate L2 is placed in the support plate jig 301′ of the intermediate support plate holder 290, and locked by the cam locking device 309. The intermediate support plate is positioned with the abutment surface 320 or 320, on one direction, and is placed against the post P′ in the other direction, placed as explained before in the post holder 224′.

A post holder 332 is located adjacent the intermediate support plate holder 290. A symmetrically identical post holder 332′ is adjacent the intermediate support plate holder 290′. The post holders 332 and 332′ are symmetrically opposed about the symmetrical axis, and are integrally fastened to the table 181. The post holders 332 and 332′ are identical to the post holders 224 and 224′, respectively, described above and depicted in FIG. 11. The post holder 332 holds the post, such as P1, parallel to the symmetrical axis in combination with the post holder 224. The position of the post P1 is at a determined distance with respect to the symmetrical axis. The lower and intermediate support plates L1 and L2 are consequently positioned according to the angled step post P1, as described previously.

An upper support plate holder 340, shown in FIG. 14, is adjacent the post holder 332 and comprises a slender plate 342 lying on the table 181. The slender plate 342 is longitudinally perpendicular to the symmetrical axis and is centered therefrom. A rectangular block 344 extends downward therefrom and is centered on the symmetrical axis. A tapped nut 346 is located at a bottom edge 348 of the rectangular block 344, and is also centered on the symmetrical axis. The rectangular block 344 penetrates the table 181 through a slot 350, engaging a slidable contact therewith, allowing for a translation of the upper support plate holder 340 upon the symmetrical axis.

A support plate jig 351 comprises a stationary plate 352 extending upward from the slender plate 342 and generally located between an end of the slender plate 342 and the symmetrical axis. The support plate jig 351 further comprises a stationary plate 354 extending upward from the slender plate 342 at an end therefrom. The stationary plates 352 and 354 both comprise pairs of pins 356, for holding sliding plates 358 and 360, respectively. The sliding plates both have a pair of obround slots 362 at bottoms thereof for sliding about the pins 356. A jig plate 364 is hinged to top edges of the sliding plates 358 and 360, by hinges or the like.

The support plate jig 351 further comprises a cam locking device 366 and operating in the same way as the cam locking device 267 in FIG. 12, and defined by a rectangular plate 368 integrally joined to a bottom surface 370 of the jig plate 364 and extending longitudinally parallel to the symmetrical axis. An end of the rectangular plate 368 clears the bottom surface 370 of the jig plate 364 and is secured to a block 372. A sleeve 374 is located at an end face therefrom, longitudinally parallel to the symmetrical axis, and bears a rod 376 and is slidable and translational engagement therewith. The rod 376 comprises at an end a handle 378 and at an opposed end a cam 380.

The support plate jig 351 further comprises a post stopping blade 382, integrally joined to an edge 384 of the jig plate 364 and extending away from the symmetrical axis. A support plate jig 351′ is symmetrically identical to the support plate jig 351.

A guide plate 386 extends from an edge 388 of the slender plate 342 and is longitudinally parallel to the symmetrical axis. The guide plate 386 slides in a housing 390 consisting in side abutments 392 and 394, integrally fastened to the table 161, and a top plate 396. A guide plate 386, and a housing 390′ are symmetrically identical to the guide plate 386 and the housing 390, respectively.

A pointer 398 is connected to an edge 400 of the slender plate 342, and points away from the symmetrical axis. A ruler 402 is fixedly joined to the table 181, parallel to the symmetrical axis. The pointer 398 is near the ruler 402 to allow a user to take readings therefrom. Symmetrically identical pointer 398′ and ruler 402′ are opposed to the pointer 398 and ruler 402 about the symmetrical axis.

During the assembly of the angled step post, the upper support plate L3 is placed in the support plate jig 351′ of the upper support plate holder 340, and locked by the cam locking device 366. The upper support plate is positioned with the post stopping blade 382′ on one direction, and is placed against the post P1 in the other direction, the post P1 being placed in the post holder 224′. The post P1 abuts the post stopping blade 382′ for the precise positioning thereof longitudinally about the symmetrical axis.

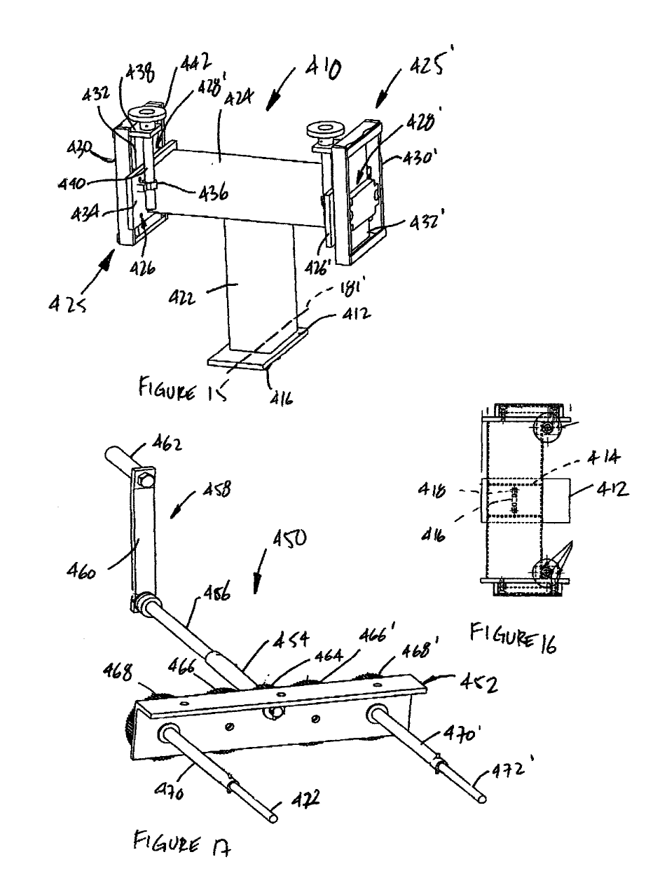

An upper step support jig 410 is located adjacent the upper support plate holder 340 and is shown in FIGS. 15 and 16. The upper step support jig 410 comprises a rectangular plate 412. A rectangular block 414 is secured to at a bottom of the rectangular plate 412. A tapped nut 416 is located at a bottom edge 418 of the rectangular block 414. The tapped nut 416 is centered about the symmetrical axis. The rectangular block 414 penetrates the table 181 through a slot 420. The rectangular block 414 engages in slidable contact therewith to translate parallel to the symmetrical axis.

A beam 422 extends upward from the rectangular plate 412. A transverse beam 424 is connected thereto and centered at a top of the beam 422. A frame jig is generally shown at 425 and extends at an end of the transverse beam 424. A housing 426, connected to the transverse beam 424, defines a slot 428. A rectangular frame 430 comprises a keyway located in the middle thereof. The keyway 432 engages in slidable contact with the slot 428 to move upward and downward. A wall 434 of the housing 426 comprises a tapped nut 436 fixedly joined thereto. A plate 438 extends from an inside of the rectangular frame 430 towards the symmetrical axis. The plate 438 bears threaded rod 440, which engages an operative contact with the tapped nut 436. An opposed end of the threaded rod comprises a cap 442 for turning the threaded rod in either direction. A rotation of the threaded rod will translate the rectangular frame 430 upward or downward, as known in the art. The rectangular frame 430 is sized to be covered by a step support. A frame jig 425′ is symmetrically identical to the frame jig 425.

According to the side of the angled step post (left or right-turn), a mounted stringer, for instance S2 of FIG. 1, will be placed thereon by the step support D covering the frame 430′. The upward and downward translation of the rectangular frame 430 and 430′, as explained above, allows to determine the horizontal position of the second straight portion of stairway about the angled steps.

During the assembly of the angled step post, once the post P1 is placed as described above, and once the step support D of the stringer S2 is placed on the upper step support jig 410, a connecting plate N2 is fastened from the post P1 to the stringer S2.

Referring to FIG. 17, a transmission 450, is located below the table 181 and is connected thereto by an L-shaped beam 452, perpendicular to the symmetrical axis, and integrally fastened to the table 181. A threaded rod 454 extends from the L-shaped beam 452 and is axially centered on the symmetrical axis. The threaded rod 454 rotates about the L-shaped beam 452. A threaded rod 456 extends at an end of the threaded rod 454, opposed to the L-shaped beam 452. The threaded rod 456 is concentric with the threaded rod 454 and, consequently, is axially centered about the symmetrical axis. A handle 458, located at an end of the threaded rod 456, comprises a slender plate 460 and a rod 462. The rotation of the handle 458 allows for the rotation of the threaded rods 454 and 456 about their longitudinal axis.

A spur gear 464, fixedly centered on the threaded rod 454, is adjacent the L-shaped beam 452 and is in operative contact with a spur gear 466, which in turn is in operative contact with a spur gear 468. The spur gear 468 rotates with a threaded rod 470 extending at an opposed side of the L-shaped beam 452. The threaded rod 470 is longitudinally parallel to the symmetrical axis. A threaded rod 472 is concentrically connected to an opposed end of the threaded rod 470 and is therefore longitudinally parallel to the symmetrical axis.

Spur gears 466′, 468′, threaded rods 470′, 472′ are symmetrically identical to spur gears 466, 468, threaded rods 470, 472.

A rotation of the handle 458 is transmitted to the threaded rod 456, which is connected to the threaded rod 454. This will allow a rotation of the spur gear 464 which will transmit the motion to the spur gear 468 via the spur gear 466, as known in the art. The spur gear 468 will then transmit the rotation to the threaded rod 470 which in turn transmits the rotation to the threaded rod 472. Similarly spur gears 466′, 468′ and threaded rods 470′ and 472′ are rotated.

The tapped nuts 254 and 254′ of the lower support plate holder 248 are engaged on threaded rods 472 and 472′, respectively. A rotation of the threaded rods 472 and 472′ will be transformed into a translation of the lower support plate holder 248 on the symmetrical axis. The guide plates 280 and 280′ will ensure a stable translation of the lower support holder 248.

Similarly, the tapped nuts 296 and 296′ of the intermediate support plate holder 290 are engaged on the threaded rods 470 and 470′, respectively. A rotation of the threaded rods 470 and 470′ will be transformed into a translation of the intermediate support plate holder 290 on the symmetrical axis. The guide plates 322 and 322′ will ensure a stable translation of the intermediate support plate holder 290 by the sliding contact with the housings 324 and 324′.

The tapped nut 346 of the upper support plate holder 340 is engaged on the threaded rod 454. A rotation of the threaded 454 will be transformed into a translation of the upper support plate holder 340 on the symmetrical axis. The guide plates 386 and 386′ will ensure a stable translation of the upper support plate holder 340 by the slidable contact with the housings 390 and 390′.

Finally, the tapped nut 416 of the second step support jig 410 is engaged on the threaded rod 456. A rotation of the threaded rod 456 will be transformed into a translation of the second step support jig 410 on the symmetrical axis.

The threaded rods and the spur gears of the transmission 450 are threaded and sized in order to equally space the slidable elements they are operatively connected to. The first step support jig 216 is integrally fastened to the table 181 and will consequently remain stationary. The lower support plate holder 248, translating as described above, will be at a distance X of the step support jig 216. The intermediate support plate holder 290, translating as described above, will be spaced by the same distance X from the lower support plate holder 248. The intermediate support plate holder 290 will consequently be at a distance 2X of the step support jig 216, distance 2X being the double of the distance X. Similarly the upper support plate holder 340 and the second step support jig 410 will be at distances 3X and 4X of the step support jig 216. The distances between the step support jig 216, the lower support plate holder 248, the intermediate support plate holder 290, the upper support plate holder 340 and the second step support jig 410 will always be equivalent when translating because of the transmission 450.

Once the lower, intermediate and upper support plates L1, L2 and L3 are placed in the support plate holders 248′, 290′ and 340′ respectively, and post P1 is locked in the post holders 224′ and 332′ with an end of the post P1 abutting the post stopping blade 382′, the user is ensured that the support plates L1, L2 and L3 are precisely placed on the angled step post P, as indicated by the pointer 398, on the ruler 402′. With the angled step post bench 180 holding these pieces, as required for the assembly of the angled step post P, one can proceed with the welding or the attachment of the support plates thereto. If the frame was to make a right-turn at the angled step portion rather than the left-turn depicted in FIG. 1, the symmetrical identical elements (without ′) would have been used.

### Landing Post Bench

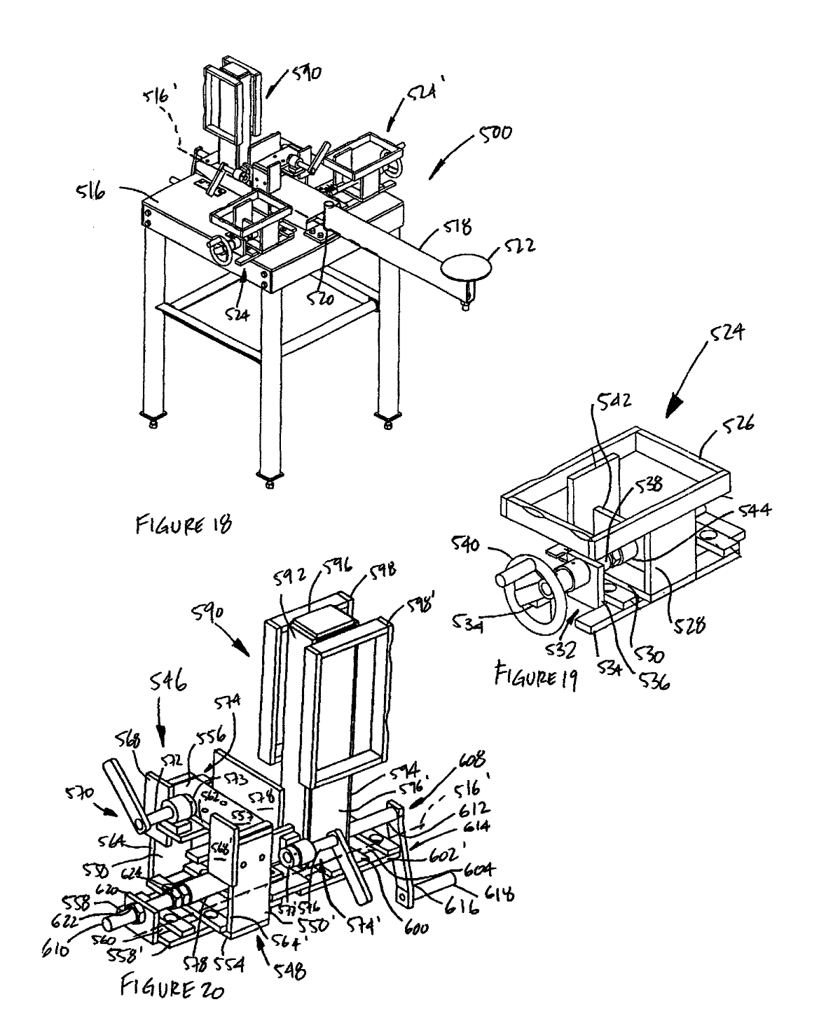

A landing post bench is generally shown at 500 in FIG. 18. It is used for mounting and assembling a landing post P0, shown in FIG. 1. The landing post P0 comprises a post P2, two support plates M1, M2 extending laterally therefrom. The lower end of the landing post P0 comprises a connecting plate N3 for attachment to the stringer S2. The upper end of the landing post P0 comprises a connecting plate N4 for attachment to a stringer S3.

The landing post bench 500 is consequently adapted to assemble the landing post P0 described above. The frame of the stairway shown in FIG. 1 makes a left turn at the landing to reach a straight portion thereafter. However, the landing could have served to make a right turn, in which case a landing post symmetrically identical to the landing post P0 would be needed. Mounting such a landing post is possible with the landing post bench 500 as it comprises two symmetrically identical portions for mounting either left or right angled step post. The landing post bench 500 comprises a table 516 as shown in FIG. 18. The table 516 is passed through by a theoretical symmetrical axis 516′, hereinafter referred to as the symmetrical axis. Like reference numerals differentiated by a ′ symbol will designate hereinafter symmetrically identical parts, symmetrically opposed about the symmetrical axis.

The landing post bench 500 comprises an arm 518 extending at an end of the symmetrical axis and pivoting about a rod 520. A circular plate 522 is located at an opposed end of the arm 518.

An upper step support jig 524 is located at a corner of the table 516 adjacent the rod 520. The upper step support jig 524, shown in FIG. 19, comprises a rectangular frame 526 mounted on a U-shaped beam 528. A rectangular block is secured to a bottom plate 530 of the U-shaped beam 528. The rectangular block is slidably engaged in a channel 532, defined by the abutments 534. A housing plate 536, upwardly extending from the table 516, bears threaded rod 538, to which is fixedly connected a turn wheel 540. A plate 542, located in the U-shaped beam 528, bears a tapped sleeve 544. The threaded rod 538 is engaged in the tapped sleeve 544. In consequence thereof, one can rotate the threaded rod 538 by the turn wheel 540 to translate the upper step support jig 524 perpendicularly about the symmetrical axis. An upper step support jig 524′ is symmetrically identical to the upper step support jig 524. The rectangular frames 526 and 526′ are sized to be covered by a step support, such as step support E of FIG. 1.

According to the direction of the stairway after the landing (left or right), a stringer mounted with step supports, such as stringer S2 with step supports D and E of FIG. 1, will be placed thereon by the step support covering the frame 526′. The arm 518 is turned to be used to support the rest of the mounted stringer. The perpendicular translations of the rectangular frames 526 and 526′ about the symmetrical axis, as explained above, allows to determine the horizontal position of the third straight portion 6 of stairway about the landing portion 5.

A support plate jig 546, shown in FIG. 20, comprises a square frame 548. The square frame is defined by lateral walls 550, 550′, a bottom wall 554 and an upper wall 556. The square frame is centered about the symmetrical axis, with lateral wall 550 symmetrically opposed to lateral wall 550′. Abutments 558 and 558′ are symmetrically opposed on a bottom face of the bottom wall 554. The abutments 558 and 558′ and the bottom face of the bottom wall 554 engage a slidable contact with a bed way 560, integrally fastened to the table 516 and axially centered on the symmetrical axis. This allows for a translation of the square frame 548 upon the symmetrical axis. A tapped sleeve 578 is axially centered on an inner face of the bottom wall 554. Abutment plate 568 is connected at the intersection of an edge 564 of the lateral wall 550 and an edge 562 of the upper wall 556. An abutment plate 568′ is symmetrically opposed to the abutment plate 568 and is located at the intersection of an edge 564′ of the lateral wall 550′ and the edge 562 of the upper wall 556. A cam locking device 570, identical to the cam locking devices described previously, extends from an inner face of the upper wall 556 beyond the edge 562. The rod 572 of the cam locking device 570 is axially centered on the symmetrical axis and the cam 573 can thus move over an outer face 557 of the upper wall 556.

A cam locking device 574′, extends beyond the lateral wall 552′ from below an edge opposite the edge 564′. The rod 576′ of the cam locking device 574′ is longitudinally parallel to the symmetrical axis and the cam 577′ can thus move over an outer face of the lateral wall 550′. A cam locking device 574 extends likewise.

An abutting plate 578 is connected to both the cam locking devices 574 and 574′. The abutting plate 578 is perpendicular to the symmetrical axis and extends beyond the upper wall 556 to serve as an abutting surface for plates disposed on the outer face of the upper wall 556.

For instance, during the assembly of the landing post, the support plates M1 and M2, are placed in the support plate jig 546′, and locked by the cam locking devices 570 and 574′. The support plates M1 and M2 are positioned with the abutment surfaces 568′ and 578, respectively, longitudinally about the symmetrical axis. The post P2 is precisely placed in the stringer S3, and the support plates abut the post P2 precisely perpendicularly to the symmetrical axis.

A lower step support jig 590 is located adjacent the support plate jig 546 on the symmetrical axis. The lower step support jig 590 is defined by upwardly extending front lateral wall 592 and back lateral wall 594. The front and back lateral walls are centered on the symmetrical axis. The front and back lateral walls 592 and 594 comprise tapped holes at ends adjacent a support plate 600. The lower step support jig 590 further comprises upwardly extending side walls 596 and 596′. A rectangular frame 598 is connected to an outer face of the side wall 596. The rectangular frame 598 is sized to be covered by a step support. Similarly, A rectangular frame 598′ is connected to an outer face of the side wall 596′.

The lateral walls 592-596 upwardly extend from the support plate 600, perpendicular to and centered about the symmetrical axis. Guide plates 602 and 602′ are located on opposed ends of the support plate 600. A bed way 604, fastened to the table 516, is axially centered on the symmetrical axis. The guide plates 602 and 602′ engage a slidable contact with the bed way 604, thus allowing for the support plate 600 to translate parallel to the symmetrical axis. Consequently, the rectangular frames 598 and 598′ translate upon the symmetrical axis.

The mounted riser S3 will be placed thereon by the step support F covering the frame 598′. During the assembly of the landing post, once the post P2 is placed as described above, and once the step support F is placed on the lower step support jig 590′, a connecting plate N4 is fastened from the post P2 to the stringer S3.

A transmission 608 is axially centered over the symmetrical axis. The transmission 608 comprises a threaded rod 610, a threaded rod 612 and a handle 614. The handle 614 is defined by a plate 616 extending laterally from an end of the threaded rod 612 and fixedly joined therefrom. A rod 618 is located at an opposed end of the plate 616. The threaded rods 610 and 612 are concentric. A bearing plate 620, integrally fastened to the table 516, upwardly extends therefrom. The bearing plate 620 is adjacent the rod 520 and is perpendicular to and centered about the symmetrical axis. A tapped nut 622 is fixedly connected to an upper end of the bearing plate 620 and is axially centered about the symmetrical axis.

The threaded rod 610 is operatively engaged with the tapped nut 622. Furthermore the sleeve 578 of the support plate jig 546 is slidably engaged on the threaded rod 610. Pairs of tapped nuts 624 are integrally locked on the threaded rod 610 on either side of the sleeve 578. Consequently, the sleeve 578 of the support plate jig 546 will remain stationary about the threaded rod 610.

The threaded rod 612 is operatively engaged in the tapped holes of the front and back lateral walls 592 and 594. A rotation of the threaded rod 612 will translate the step support jig 590 about the threaded rod 612 on the symmetrical axis.

When a user turns the handles 614, the threaded rod 610 turns about the tapped nut 622. As the tapped nut 622 is integrally joined to the table 516, the threaded rod will longitudinally translate upon the symmetrical axis by its rotation. As the sleeve 578 of the support plate jig 546 is fixedly locked to the same position on the threaded rod 610, a translation of the threaded rod 610 will translate the support plate jig 546. As the threaded rod 612 is concentric and connected to the threaded rod 610 the rotation and the resulting translation of the threaded rod 610 will rotate and translate the threaded rod 612. The translation and the rotation of the threaded rod 612 will translate the step support jig 590 consequently about the symmetrical axis.

This embodiment of the transmission 608 will allow for a distance between a dateline and the support plate jig 546 to always be equal to a distance between the support plate jig 546 and the step support jig 590.

I claim:

1. A bench, adapted for mounting step supports to stringers of a modular stairway frame, comprising:
racks, adapted for holding stringers therein;
jigs, adapted for releasably locking the step supports therein;
a mechanism connecting said racks to said jigs, (i) for equally spacing and rotating the steps supports adapted therein with respect to said racks, and (ii) for mounting identical or symmetrically identical step support and stringer assemblies.

2. A bench, adapted for mounting an angled step post of a modular stairway frame, comprising:
jigs, adapted for holding support plates and vertical posts;
frames, for holding step supports;
a mechanism connecting said jigs and said frames, for ensuring a precise distancing of the support plates, the step supports, and the vertical posts adapted therein.

3. A bench, adapted for mounting a landing post of a modular stairway frame, comprising:
jigs, adapted for holding support plates and vertical posts therein;
frames, adapted for holding step supports therein; a mechanism connecting said jigs and said frames, for ensuring a precise distancing of the support plates, the step supports and the vertical posts adapted therein.
